(19) United States
(12) Patent Application Publication
(10) Pub. No.: US 2026/0274284 A1
(43) Pub. Date: Sep. 17, 2026

(54) WARNING APPARATUS, WARNING METHOD, AND WARNING SYSTEM

(71) Applicant: ISUZU MOTORS LIMITED, Yokohama-shi (JP)

(72) Inventors: Eren OHIRA, Fujisawa-shi (JP); Tatsuya NAGAOKA, Fujisawa-shi (JP)

(21) Appl. No.: 19/464,759

(22) Filed: Jan. 30, 2026

(30) Foreign Application Priority Data
Mar. 14, 2025 (JP) 2025-041190

(51) Int. Cl. B60W 50/14

(52) U.S. Cl. CPC B60W 50/14; B60W 2050/143; B60W 2050/146; B60W 2300/12; B60W 2520/105

(57) ABSTRACT

A warning apparatus includes: an acquiring section that acquires: a first acceleration which is an acceleration of a vehicle detected by a first acceleration sensor; and a second acceleration which is detected by a second acceleration sensor and is an acceleration of a securing member that secures a loaded item loaded in the vehicle; and an output section that outputs predetermined warning information when a difference between a first statistical value which is a statistical value of the first acceleration and a second statistical value which is a statistical value of the second acceleration is equal to or greater than a threshold.

### CROSS-REFERENCE TO RELATED APPLICATIONS

The present application claims priority to Japanese Patent Application number 2025-041190, filed on Mar. 14, 2025, contents of which are incorporated herein by reference in its entirety.

### BACKGROUND OF THE INVENTION

The present invention relates to a warning apparatus, a warning method, and a warning system.

Conventional loaded-item monitoring systems detect a postural change of loaded items on the basis of a relative acceleration which is the difference between an acceleration detected by an acceleration sensor provided to a vehicle and an acceleration detected by an acceleration sensor installed on the loaded items of the vehicle (e.g., Japanese Patent Application Publication No. 2017-3540).

Since the position of an acceleration sensor provided to a vehicle and the position of an acceleration sensor installed on loaded items of the vehicle are not the same position, the timings at which the acceleration sensors detect the accelerations that have changed due to the vehicle passing over a road step differ. Accordingly, there can be a problem that, even when the difference between the accelerations detected by the individual acceleration sensors is caused by the vehicle passing over a road step, a warning that loaded items of the vehicle are likely to collapse is erroneously issued undesirably.

### BRIEF SUMMARY OF THE INVENTION

The present invention has been made in view of these matters, and an object thereof is to enhance the accuracy of issuing a warning that loaded items are likely to collapse.

A warning apparatus according to a first aspect of the present invention includes: an acquiring section that acquires: a first acceleration which is an acceleration of a vehicle detected by a first acceleration sensor; and a second acceleration which is detected by a second acceleration sensor and is an acceleration of a securing member that secures a loaded item loaded in the vehicle; and an output section that outputs predetermined warning information when a difference between a first statistical value which is a statistical value of the first acceleration and a second statistical value which is a statistical value of the second acceleration is equal to or greater than a threshold.

A warning method according to a second aspect of the present invention is a warning method executed by a computer, the warning method including: an acquisition step of acquiring: a first acceleration which is an acceleration of a vehicle detected by a first acceleration sensor; and a second acceleration which is detected by a second acceleration sensor and is an acceleration of a securing member that secures a loaded item loaded in the vehicle; and an output step of outputting predetermined warning information in response to a difference between a first statistical value which is a statistical value of the first acceleration and a second statistical value which is a statistical value of the second acceleration being equal to or greater than a threshold.

A warning system according to a third aspect of the present invention includes: a first information processing apparatus provided to a vehicle and a second information processing apparatus provided outside the vehicle, the first information processing apparatus includes: an acquiring section that acquires: a first acceleration which is an acceleration of the vehicle detected by a first acceleration sensor; and a second acceleration which is detected by a second acceleration sensor and is an acceleration of a securing member that secures a loaded item loaded in the vehicle; and a transmitting section that transmits the first acceleration and the second acceleration to the second information processing apparatus, and the second information processing apparatus includes: a receiving section that receives the first acceleration and the second acceleration from the first information processing apparatus; and an output section that outputs predetermined warning information when a difference between a first statistical value which is a statistical value of the first acceleration and a second statistical value which is a statistical value of the second acceleration is equal to or greater than a threshold.

### BRIEF DESCRIPTION OF THE DRAWINGS

FIG. 1 is a drawing illustrating an overview of a vehicle S according to the present embodiment.

FIG. 2 is a drawing illustrating an example of a belt securing loaded items.

FIG. 3A is a drawing illustrating a bracket K as seen from the rear of the vehicle S.

FIG. 3B is a drawing of the bracket K as seen from the side of the vehicle S.

FIG. 3C is a drawing of the bracket K as seen from beneath the vehicle S.

FIG. 4 is a drawing illustrating an example of the difference between a first cumulative value and a second cumulative value.

FIG. 5 is a drawing illustrating an example of an instruction image.

FIG. 6 is a drawing illustrating an example of a process sequence in a warning apparatus 20.

FIG. 7 is a diagram illustrating the configuration of the vehicle S according to a first modification example.

FIG. 8 is a diagram illustrating the configuration of a warning system 1.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Overview of Vehicle S

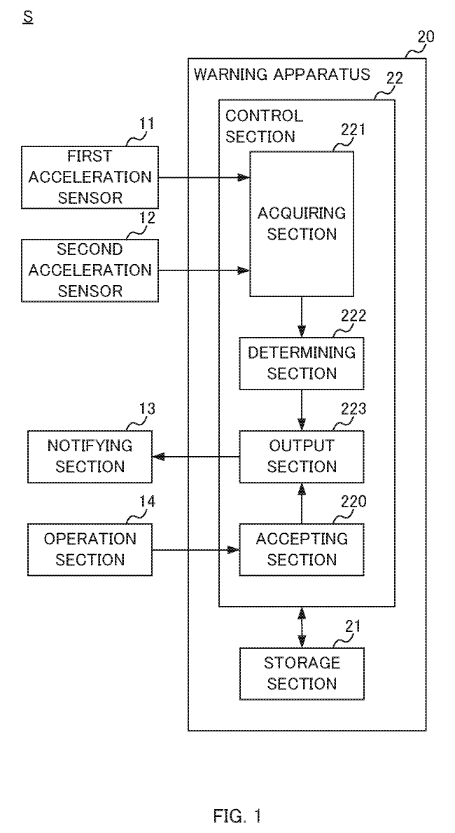

FIG. 1 is a drawing illustrating an overview of a vehicle S according to the present embodiment. The vehicle S illustrated in FIG. 1 includes a first acceleration sensor 11, a second acceleration sensor 12, a notifying section 13, an operation section 14, and a warning apparatus 20. The vehicle S is a vehicle including a cargo compartment for loading loaded items, and, for example, is a freight vehicle (i.e., truck). The vehicle S has a function of issuing a warning to a driver when loaded items loaded within the cargo compartment of the vehicle S are likely to collapse.

The first acceleration sensor 11 is a sensor that detects the acceleration of the vehicle S. For example, the first acceleration sensor 11 is included in one ECU among a plurality of ECUs (Electronic Control Units) provided to the vehicle S and detects the acceleration in each of the advancing direction, the vehicle-width direction, and the vertical direction of the vehicle S (hereinbelow, referred to as "first acceleration").

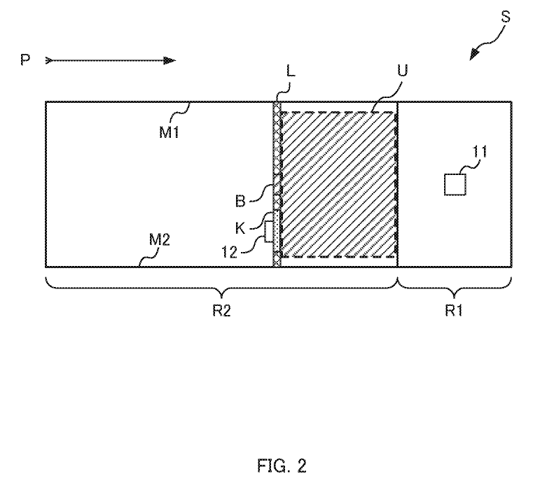

The second acceleration sensor 12 is a sensor that detects the acceleration of a securing member that secures loaded items loaded within the cargo compartment of the vehicle S. The securing member is a belt whose both ends are supported (i.e., secured) within the cargo compartment of the vehicle S. For example, the securing member is a lashing belt. FIG. 2 is a drawing illustrating an example of the belt securing loaded items. In FIG. 2, a drawing of the interior of the vehicle S as seen from above is illustrated. As illustrated in FIG. 2, the vehicle S has a cabin R1 and a cargo compartment R2. The cabin R1 is provided on the front side of the vehicle S in an advancing direction P, and the cargo compartment R2 is provided on the rear side of the cabin R1 in the advancing direction P. By both ends of a belt L in the longitudinal direction being coupled to coupling sections provided on a side surface M1 and a side surface M2 of the cargo compartment R2 and the longitudinal length of the belt L being adjusted with a buckle B positioned at the central section of the belt L in the longitudinal direction, the belt L secures loaded items U such that the loaded items U do not move in a direction opposite to the advancing direction P (toward the rear of the cargo compartment R2).

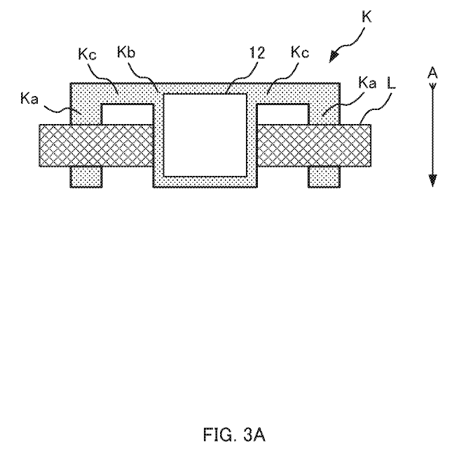

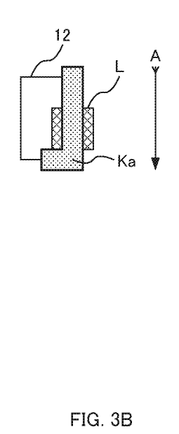

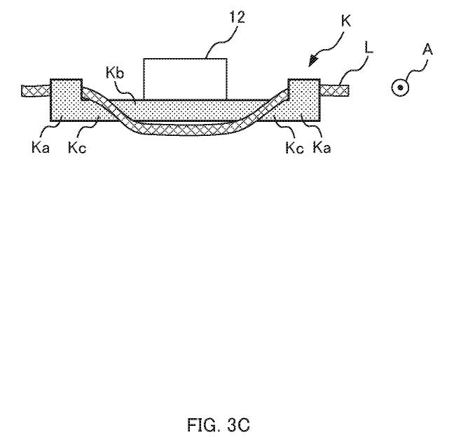

As illustrated in FIG. 2, the second acceleration sensor 12 is attached to a bracket K installed at a position different from the position of the buckle B on the belt L. FIGS. 3A, 3B, and 3C are drawings illustrating an example of the bracket K. FIG. 3A is a drawing of the bracket K as seen from the rear of the vehicle S, FIG. 3B is a drawing of the bracket K as seen from the side of the vehicle S, and FIG. 3C is a drawing of the bracket K as seen from beneath the vehicle S. The bracket K has: a central section Kb; two separated sections Ka that are separated from the central section Kb in the longitudinal direction of the belt L; and two coupling sections Kc coupling the central section Kb and the two separated sections Ka.

The bracket K is installed on the belt L such that the separated sections Ka are positioned in front of the belt L in the advancing direction of the vehicle S (i.e., between the belt L and the loaded items U), and the central section Kb is positioned behind the belt L in the advancing direction of the vehicle S. The back surface (a surface opposite to the surface on which the second acceleration sensor 12 is attached) of the central section Kb is in contact with the belt L. The coupling section Kc may contact the belt L in the widthwise direction of the belt L. By the bracket K being installed in this manner, the belt L contacts the back surface of the central section Kb. Accordingly, it becomes easier for the second acceleration sensor 12 attached to the front surface of the central section Kb to detect the acceleration of the belt L.

For example, the second acceleration sensor 12 is a beacon and detects the acceleration in each of the axial directions of three mutually orthogonal axes. For example, the second acceleration sensor 12 is attached to the central section Kb of the bracket K installed on the belt L securing the loaded items U such that the axial direction of one axis among the axial directions of the three axes coincides with the vertical direction of the vehicle S. For example, the vertical direction is a direction A illustrated in FIGS. 3A, 3B, and 3C. By being attached in this manner, the second acceleration sensor 12 can detect the acceleration (hereinbelow, referred to as "second acceleration") of the belt L in each of the advancing direction, the vehicle-width direction, and the vertical direction of the vehicle S.

Returning to FIG. 1, the notifying section 13 includes a display included in the instrument panel of the vehicle S and a speaker provided around the instrument panel. When loaded items U are likely to collapse, the notifying section 13 provides a notification to the driver by causing a display area that displays information recorded by an operation recorder (tachograph) in the display area of the display to display a warning image or causing a speaker to output a warning sound. The operation section 14 is a touch panel or a switch included in the instrument panel or a steering-wheel switch.

The warning apparatus 20 is a housing including electronic components or a printed board on which electronic components are implemented and is an apparatus that executes a process of causing the notifying section 13 to provide a notification when loaded items U are likely to collapse. For example, the warning apparatus 20 acquires the first acceleration of the vehicle S detected by the first acceleration sensor 11 and the second acceleration of the belt L detected by the second acceleration sensor 12 at predetermined interval (e.g., every one second). Next, the warning apparatus 20 calculates the difference between a statistical value of the first acceleration and a statistical value of the second acceleration for each of the advancing direction, the vehicle-width direction, and the vertical direction of the vehicle S and determines whether or not loaded items U are likely to collapse on the basis of the calculated difference. For example, the statistical values are cumulative values or average values. Details of the statistical values are mentioned later.

Then, when the warning apparatus 20 determines that loaded items U are likely to collapse, the warning apparatus 20 causes the notifying section 13 to provide a notification by outputting, to the notifying section 13, warning information representing that loaded items U are likely to collapse. Through this operation, the warning apparatus 20 can identify that loaded items U are likely to collapse and cause the notifying section 13 to provide a notification on the basis of the first acceleration and the second acceleration at a plurality of timings. Then, the warning apparatus 20 can prevent an erroneous determination that loaded items U are likely to collapse from being made due to a timing at which the first acceleration changes being different from a timing at which the second acceleration changes in a state where loaded items U are unlikely to collapse, and the warning apparatus 20 can prevent the notifying section 13 from being caused to provide a notification erroneously. As a result, the warning apparatus 20 can enhance the accuracy of issuing a warning that loaded items U are likely to collapse.

Specifically, even when a timing at which the first acceleration changes is different from a timing at which the second acceleration changes, the warning apparatus 20 can decide that the difference between the individual accelerations has increased temporarily due to the vehicle S passing over a road step, if the difference between the first statistical value and the second statistical value is small. That is, when the difference between the first statistical value and the second statistical value is small, the warning apparatus 20 can determine that loaded items U are unlikely to collapse. On the other hand, when the difference between the first statistical value and the second statistical value is large, the warning apparatus 20 can decide that loaded items U are likely to collapse due to the loaded items U being not appropriately secured. For example, the state in which "the loaded items U are not appropriately secured" includes a state where the belt L is loosened and a state in which the belt L is separated from the side surface M1, the side surface M2, or the loaded items U.

Furthermore, on the basis of the second acceleration of the belt L that can secure a plurality of the loaded items U, the warning apparatus 20 can determine whether or not loaded items U are likely to collapse. Accordingly, even when the number of loaded items U is large, it is not necessary to provide the same number of the second acceleration sensors 12 as the number of the loaded items U, and the warning apparatus 20 can execute determination as to whether or not loaded items U are likely to collapse using a smaller number of the second acceleration sensors 12 than the number of the loaded items U. As a result, the warning apparatus 20 can reduce the cost for detecting that loaded items U are likely to collapse.

Hereinbelow, the configuration and operation of the warning apparatus 20 are explained in detail.

### Configuration of Warning Apparatus 20

As illustrated in FIG. 1, the warning apparatus 20 has a storage section 21 and a control section 22. The control section 22 has an accepting section 220, an acquiring section 221, a determining section 222, and an output section 223.

For example, the storage section 21 has a storage medium such as a ROM (Read Only Memory), a RAM (Random Access Memory), a HDD (Hard Disk Drive), or a SSD (Solid State Drive). The storage section 21 has stored therein a program for being executed by the control section 22. The storage section 21 has stored therein various types of information for detecting that loaded items U are likely to collapse and for causing the notifying section 13 to provide a notification that loaded items U are likely to collapse.

For example, the control section 22 is a processor such as a CPU (Central Processing Unit) or an ECU. By executing the program stored in the storage section 21, the control section 22 functions as the accepting section 220, the acquiring section 221, the determining section 222, and the output section 223. Note that the control section 22 may include one processor or may include a plurality of processors or a combination of one or more processors and an electronic circuit.

The accepting section 220 accepts an operation of the operation section 14 executed by the driver of the vehicle S. For example, the accepting section 220 accepts an operation in which the driver presses the touch panel or the switch included in the operation section 14 in order to indicate that loaded items U are not loaded in the cargo compartment R2 of the vehicle S. Specifically, the accepting section 220 accepts operation information representing that the driver has pressed the touch panel or the switch in order to indicate that loaded items U are not loaded. Through this operation, the warning apparatus 20 can stop a process for issuing a warning that loaded items U are likely to collapse when loaded items U are not loaded in the cargo compartment R2. Note that the warning apparatus 20 executes a process for issuing a warning that loaded items U are likely to collapse when the accepting section 220 has not accepted the operation information.

The acquiring section 221 acquires the first acceleration, which is the acceleration of the vehicle S detected by the first acceleration sensor 11. The first acceleration includes the acceleration in each of the advancing direction, the vehicle-width direction, and the vertical direction of the vehicle S. For example, the acquiring section 221 acquires the first acceleration from the first acceleration sensor 11 at predetermined intervals (e.g., every one second) via a wired network such as a CAN (Controller Area Network). In the following explanation, the predetermined intervals are referred to as "intervals F."

The acquiring section 221 acquires the second acceleration that is detected by the second acceleration sensor 12 and is the acceleration of the belt L that secures loaded items U loaded in the vehicle S. The second acceleration includes the acceleration in each of the advancing direction, the vehicle-width direction, and the vertical direction of the vehicle S. For example, the acquiring section 221 acquires the second acceleration that is detected by the second acceleration sensor 12, which is different from the first acceleration sensor 11, and is the acceleration of the belt L that secures one or more loaded items U loaded in the vehicle S. Specifically, for example, the acquiring section 221 acquires the second acceleration detected by the second acceleration sensor 12 attached to the central section Kb of the bracket K installed on the belt L via a wireless network such as Bluetooth (registered trademark) at the intervals F.

When there are a plurality of the belts L in the cargo compartment R2 of the vehicle S, the acquiring section 221 may acquire the second acceleration from a plurality of the second acceleration sensors 12 attached to the plurality of belts L in the cargo compartment R2 of the vehicle S at the intervals F. For example, the acquiring section 221 acquires, from each second acceleration sensor 12, sensor identification information (hereinbelow, referred to as "sensor ID") for identifying the acceleration sensor and the second acceleration at the intervals F.

The determining section 222 determines whether or not loaded items U are likely to collapse on the basis of the first acceleration of the vehicle S and the second acceleration of the belt L. First, the determining section 222 calculates the first statistical value, which is a statistical value of the first acceleration, and the second statistical value, which is a statistical value of the second acceleration. For example, the determining section 222 calculates a first cumulative value which is the cumulative value of the first acceleration as the first statistical value and calculates a second cumulative value which is the cumulative value of the second acceleration as the second statistical value. Specifically, the determining section 222 calculates the first cumulative value, which is the cumulative value of the absolute value of the first acceleration, and the second cumulative value, which is the cumulative value of the absolute value of the second acceleration, at the intervals F. For example, the determining section 222 calculates the first cumulative value and the second cumulative value of each of the advancing direction, the vehicle-width direction, and the vertical direction of the vehicle S at the intervals F.

The determining section 222 may calculate a first average value which is the average value of the first acceleration as the first statistical value and calculate a second average value which is the average value of the second acceleration as the second statistical value. In this case, for example, the determining section 222 calculates the first average value, which is the average value of the absolute value of the first acceleration, and the second average value, which is the average value of the absolute value of the second acceleration, at the intervals F. For example, the determining section 222 calculates the first average value and the second average value of each of the advancing direction, the vehicle-width direction, and the vertical direction of the vehicle S at the intervals F.

Then, the determining section 222 determines that loaded items U are likely to collapse when the difference between the first statistical value and the second statistical value is equal to or greater than a threshold and determines that loaded items U are unlikely to collapse when the difference between the first statistical value and the second statistical value is smaller than the threshold. The threshold is a product obtained by multiplying the maximum value of the difference between the first statistical value and the second statistical value that can occur when loaded items U are unlikely to collapse by a predetermined coefficient (e.g., 1.1). The threshold is decided through experiments or simulations and is stored in the storage section 21. For example, the determining section 222 determines that loaded items U are likely to collapse, in response to the difference between the first statistical value and the second statistical value being equal to or greater than the threshold in at least one direction from among the advancing direction, the vehicle-width direction, and the vertical direction of the vehicle S.

As an example, the determining section 222 determines whether or not the difference between the first cumulative value calculated as the first statistical value and the second cumulative value calculated as the second statistical value is equal to or greater than the threshold and outputs a determination result which is a result of the determination to the output section 223. As another example, the determining section 222 determines whether or not the difference between the first average value calculated as the first statistical value and the second average value calculated as the second statistical value is equal to or greater than the threshold and outputs a determination result which is a result of the determination to the output section 223. The following explains mainly a case in which the first statistical value is the first cumulative value, and the second statistical value is the second cumulative value.

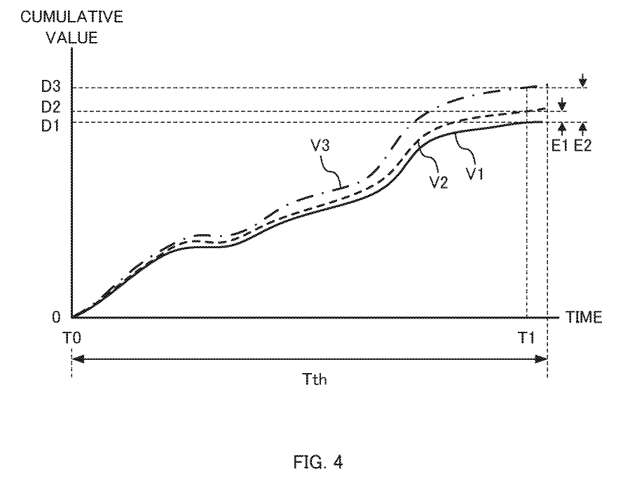

FIG. 4 is a drawing illustrating an example of the difference between the first cumulative value and the second cumulative value. The horizontal axis in FIG. 4 represents time, and the vertical axis in FIG. 4 represents the cumulative values (first cumulative value and second cumulative value) in one direction among the advancing direction, the vehicle-width direction, and the vertical direction of the vehicle S. FIG. 4 illustrates a first cumulative value V1, a second cumulative value V2 in a case in which loaded items U are unlikely to collapse, and a second cumulative value V3 in a case in which loaded items U are likely to collapse.

When loaded items U are unlikely to collapse, the determining section 222 determines that loaded items U are unlikely to collapse, in response to a difference E1 between a first cumulative value D1 and a second cumulative value D2 being smaller than the threshold at time T1. On the other hand, when loaded items U are likely to collapse, the determining section 222 determines that loaded items U are likely to collapse, in response to a difference E2 between the first cumulative value D1 and a second cumulative value D3 being equal to or greater than the threshold at time T1.

Since the position of the first acceleration sensor 11 and the position of the second acceleration sensor 12 in the vehicle S are different from each other, for example, the timings at which the first acceleration sensor 11 and the second acceleration sensor 12 detect the accelerations that have changed due to the vehicle S passing over a road step differ. Accordingly, the difference between the first acceleration and the second acceleration for each interval F increases depending on the traveling of the vehicle S temporarily even when loaded items U are unlikely to collapse, in some cases. Because of this, the warning apparatus 20 cannot assess whether the difference between the first acceleration and the second acceleration for each interval F is caused by the traveling of the vehicle S or caused by loaded items U being likely to collapse.

In view of this, the determining section 222 determines whether or not loaded items U are likely to collapse on the basis of the difference between the first cumulative value and the second cumulative value as mentioned above. Through this operation, the determining section 222 can determine whether or not loaded items U are likely to collapse on the basis of the accelerations detected by the individual acceleration sensors in predetermined periods (plurality of timings). Because of this, compared to a case in which it is determined whether or not loaded items U are likely to collapse on the basis of the accelerations detected by the individual acceleration sensors at each timing, the determining section 222 can reduce the influence of the difference between timings at which changes in the accelerations are detected. As a result, the determining section 222 can determine whether or not loaded items U are likely to collapse highly accurately and accordingly can more easily prevent load collapse of loaded items U. That is, it becomes possible for the determining section 222 to prevent a sensing error as to whether or not loaded items U are likely to collapse.

For example, when there are a plurality of the belts L in the cargo compartment R2 of the vehicle S, the determining section 222 calculates the second statistical value of each of a plurality of the second acceleration sensors 12 attached to the plurality of belts L. Next, for example, the determining section 222 identifies the second acceleration sensor 12 attached to a belt L securing loaded items U that are likely to collapse, by determining, for each second acceleration sensor 12, whether or not the difference between the first statistical value and the second statistical value is equal to or greater than the threshold. Then, the determining section 222 determines that the loaded items U which are secured by the belt L having attached thereto the identified second acceleration sensor 12 are likely to collapse.

For example, when the difference between the first cumulative value, which is the first statistical value, and the second cumulative value, which is the second statistical value, is equal to or greater than the threshold, the determining section 222 determines that loaded items U secured by the belt L having attached thereto an second acceleration sensor 12 from which the second acceleration included in the second cumulative value has been acquired are likely to collapse. On the other hand, when the difference between the first cumulative value and the second cumulative value is smaller than the threshold, the determining section 222 determines that loaded items U secured by the belt L having attached thereto a second acceleration sensor 12 from which the second acceleration included in the second cumulative value has been acquired are unlikely to collapse.

For example, the determining section 222 initializes the first cumulative value and the second cumulative value when a predetermined length of time has elapsed or the vehicle S has traveled a predetermined distance from a time point at which the calculation of the first cumulative value and the second cumulative value has been started. The predetermined length of time and the predetermined distance are decided through experiments or simulations and are stored in the storage section 21. For example, the determining section 222 initializes the first cumulative value V1 and the second cumulative value V2 or the second cumulative value V3 (i.e., the second cumulative value calculated by the determining section 222) to 0 at a time at which a predetermined length of time Tth has elapsed from time T0 illustrated in FIG. 4. Through this operation, the determining section 222 can regularly return the cumulative difference, which increases as the vehicle S travels, to 0 and accordingly can highly accurately determine whether or not loaded items U are likely to collapse even when the vehicle S travels a long distance or for a long time.

Note that when the determining section 222 calculates the first average value of the first acceleration as the first statistical value and calculates the second average value of the second acceleration as the second statistical value, the determining section 222 need not initialize the first average value and the second average value even when the predetermined length of time has elapsed or the vehicle S has traveled the predetermined distance. This is because the first average value and the second average value do not increase over time or as the traveling distance increases, unlike the first cumulative value and the second cumulative value. By using the first average value and the second average value in this manner, the determining section 222 can reduce the processing load for determining whether or not loaded items U are likely to collapse.

The output section 223 outputs warning information representing a determination result which is a result of determination by the determining section 222 as to whether or not loaded items U are likely to collapse. For example, when the determining section 222 determines that loaded items U are likely to collapse, the output section 223 outputs warning information representing that load collapse is likely to occur. That is, when the difference between the first statistical value, which is the statistical value of the first acceleration, and the second statistical value, which is the statistical value of the second acceleration, is equal to or greater than the threshold, the output section 223 outputs predetermined warning information. For example, when the difference between the first statistical value and the second statistical value is equal to or greater than the threshold in at least one direction among the advancing direction, the vehicle-width direction, and the vertical direction of the vehicle S, the output section 223 outputs predetermined warning information.

Then, by outputting warning information, the output section 223 causes the display included in the notifying section 13 to display a warning image or causes the speaker included in the notifying section 13 to output a warning sound. For example, by outputting warning information, the output section 223 causes the display included in the instrument panel of the vehicle S to display a warning image representing that loaded items U are likely to collapse.

For example, by outputting warning information, the output section 223 causes the speaker provided around the instrument panel of the vehicle S to output a sound corresponding to a message that loaded items U are likely to collapse or a warning sound.

On the other hand, when the determining section 222 determines that loaded items U are unlikely to collapse, the output section 223 does not cause the notifying section 13 to execute warning image display and warning sound output by outputting warning information representing that loaded items U are unlikely to collapse. When the determining section 222 determines that loaded items U are unlikely to collapse, the output section 223 need not output warning information.

When there are a plurality of the second acceleration sensors 12 attached to a plurality of the belts L in the cargo compartment R2 of the vehicle S, the output section 223 acquires, from the determining section 222, a determination result of determination as to whether or not loaded items U are likely to collapse for each of the second acceleration sensors 12. Next, by referring to the determination result, the output section 223 identifies the second acceleration sensor 12 attached to a belt L securing loaded items U determined to be likely to collapse from among the plurality of second acceleration sensors 12. Then, the output section 223 outputs warning information representing the identified second acceleration sensor 12.

That is, the output section 223 outputs warning information representing one or more second acceleration sensors 12 whose difference between the first statistical value and the second statistical value is equal to or greater than the threshold from among the plurality of second acceleration sensors 12. Then, by outputting warning information, the output section 223 causes the display included in the notifying section 13 to display an image representing the one or more second acceleration sensors 12 attached to the belts L securing loaded items U that are likely to collapse. For example, by outputting warning information representing one or more second acceleration sensors 12, the output section 223 causes the display included in the instrument panel of the vehicle S to display an image representing sensor IDs of the one or more second acceleration sensors 12 attached to the belts L securing loaded items U that are likely to collapse.

The output section 223 may output determination information including at least any one of the difference between the first statistical value and the second statistical value calculated by the determining section 222, the first statistical value, and the second statistical value. Through this operation, the output section 223 can cause an operation recorder to record, as information recorded by the operation recorder, at least any one of the difference between the first statistical value and the second statistical value, the first statistical value, and the second statistical value or cause the display that the notifying section 13 has to display at least any one of the difference between the first statistical value and the second statistical value, the first statistical value, and the second statistical value.

Meanwhile, the second acceleration sensor 12 (i.e., beacon) is activated by a user (e.g., the driver of the vehicle S) operating a switch that the second acceleration sensor 12 has. Accordingly, when the user has forgotten to perform an operation of activating the second acceleration sensor 12 after attaching the second acceleration sensor 12 to the belt L, the second acceleration sensor 12 cannot output the second acceleration.

In view of this, for example, in response to the acquiring section 221 not being able to acquire the second acceleration after a driving source of the vehicle S has started driving, the output section 223 outputs instruction information for prompting the driver of the vehicle S to activate the second acceleration sensor 12. For example, by outputting the instruction information, the output section 223 causes the display included in the notifying section 13 to display an instruction image prompting activation of the second acceleration sensor 12.

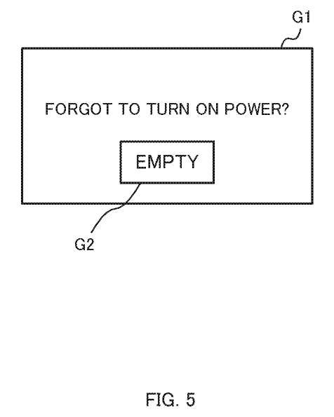

FIG. 5 is a drawing illustrating an example of an instruction image. For example, by outputting the instruction information to the notifying section 13, the output section 223 causes the display that the notifying section 13 has to display an instruction image G1 representing a message "Forgot to turn on power?." Through this operation, the output section 223 can prompt the driver of the vehicle S to notice that the second acceleration sensor 12 is not activated.

Even when the second acceleration sensor 12 is not activated since loaded items U are not loaded in the cargo compartment R2 of the vehicle S (even when not activating the second acceleration sensor 12 is a correct operation), the output section 223 causes the instruction image G1 to be displayed. In view of this, for example, the output section 223 causes the instruction image G1 including a notification image G2 for allowing the driver to notify the warning apparatus 20 that loaded items U are not loaded to be displayed.

Then, the output section 223 stops output of the instruction information in response to the accepting section 220 accepting an operation in which the driver presses an area of the touch panel corresponding to the notification image G2 or the switch in the operation section 14. By the output section 223 stopping output of the instruction information, the notifying section 13 hides the instruction image G1. Through this operation, the warning apparatus 20 can hide the instruction image G1 when loaded items U are not loaded in the cargo compartment R2. Then, the warning apparatus 20 can stop the process of determining whether or not loaded items U are likely to collapse.

### Process Sequence in Warning Apparatus 20

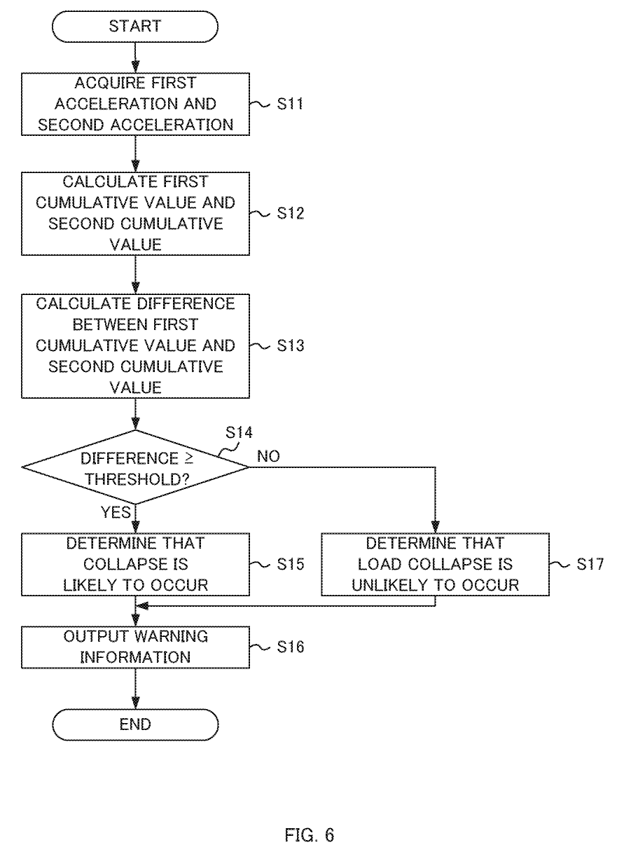

FIG. 6 is a drawing illustrating an example of a process sequence in the warning apparatus 20. The process sequence illustrated in FIG. 6 is a process sequence representing a process in which whether or not loaded items U are likely to collapse is determined on the basis of the first acceleration and the second acceleration in one direction among the advancing direction, the vehicle-width direction, and the vertical direction of the vehicle S. As an example, FIG. 6 illustrates an operation in which the determining section 222 calculates the first cumulative value as the first statistical value and calculates the second cumulative value as the second statistical value. For example, the warning apparatus 20 executes the process sequence illustrated in FIG. 6 at the intervals F.

The acquiring section 221 acquires the first acceleration detected by the first acceleration sensor 11 and the second acceleration detected by the second acceleration sensor 12 (S11). On the basis of one or more values of the first acceleration and one or more values of the second acceleration acquired at the interval F, the determining section 222 calculates the first cumulative value, which is the cumulative value of the absolute value of the first acceleration, and the second cumulative value, which is the cumulative value of the absolute value of the second acceleration (S12). The determining section 222 calculates the difference between the first cumulative value and the second cumulative value (S13).

When the difference between the first cumulative value and the second cumulative value is equal to or greater than the threshold (YES at S14), the determining section 222 determines that loaded items U are likely to collapse (S15) and outputs warning information representing that loaded items U are likely to collapse (S16). On the other hand, when the difference between the first cumulative value and the second cumulative value is smaller than the threshold (NO at S14), the determining section 222 determines that loaded items U are unlikely to collapse (S17) and outputs warning information representing that loaded items U are unlikely to collapse (S16). Then, the warning apparatus 20 ends the process.

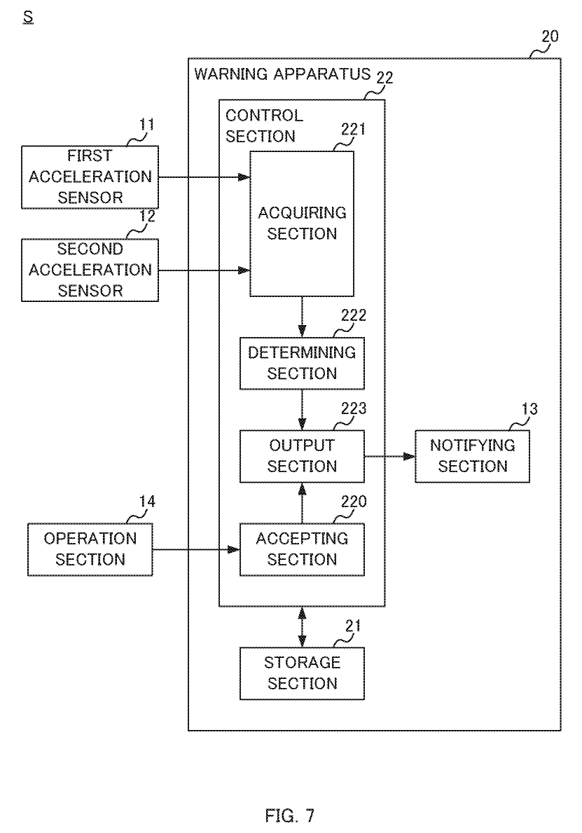

### First Modification Example

Whereas the explanation above illustrates an example of the operation in which the output section 223 outputs warning information to the notifying section 13 provided outside the warning apparatus 20, this is not the sole example. The warning apparatus 20 may have the notifying section 13. FIG. 7 is a diagram illustrating the configuration of the vehicle S according to a first modification example. The vehicle S illustrated in FIG. 7 is different from the vehicle S illustrated in FIG. 1 in that the warning apparatus 20 has the notifying section 13 and is the same as the vehicle S illustrated in FIG. 1 in other respects. The notifying section 13 includes a display included in the instrument panel of the vehicle S and a speaker provided around the instrument panel. Then, in response to acceptance of warning information output by the output section 223, the notifying section 13 causes the display to display a warning image and causes the speaker to output a warning sound.

### Second Modification Example

The explanation above illustrates an example of the configuration in which the vehicle S includes the warning apparatus 20, this is not the sole example. The configuration that the warning apparatus 20 described above has may be included in a warning system having the warning apparatus 20 provided to the vehicle S and an information processing apparatus provided outside the vehicle S.

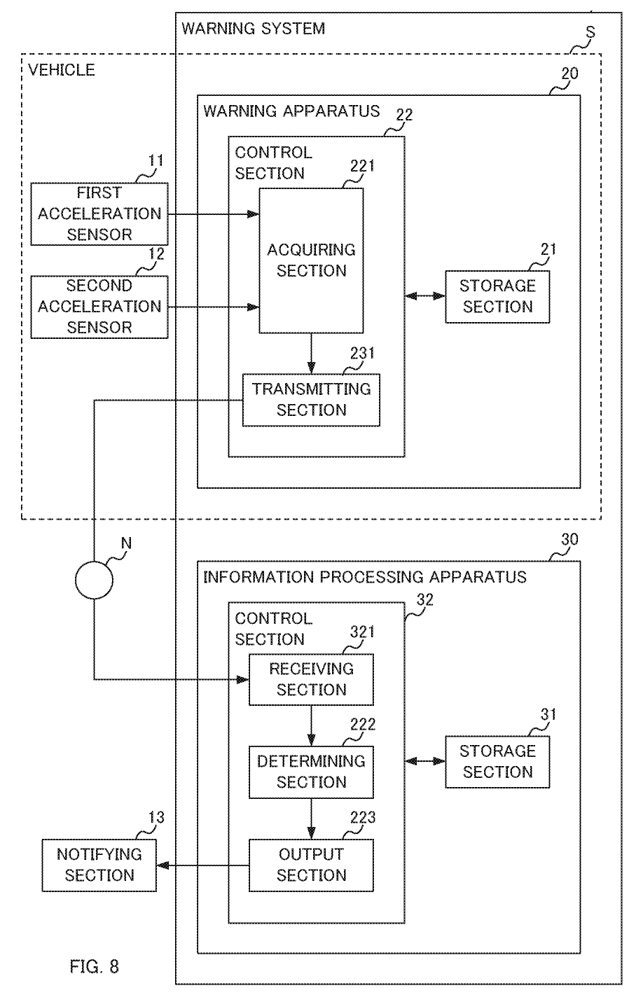

FIG. 8 is a diagram illustrating the configuration of a warning system 1. The warning apparatus 20 has the storage section 21 and the control section 22, and the control section 22 has the acquiring section 221 and a transmitting section 231. An information processing apparatus 30 has a storage section 31 and a control section 32, and the control section 32 has a receiving section 321, the determining section 222, and the output section 223. The warning apparatus 20 and the information processing apparatus 30 are communicatively connected with each other via a network N such as the Internet, an intranet, a wireless LAN (Local Area Network), or a mobile communication network. The vehicle S illustrated in FIG. 8 is different from the vehicle S illustrated in FIG. 1 in that the warning apparatus 20 has the transmitting section 231, and the warning apparatus 20 does not have the determining section 222 and the output section 223. Furthermore, FIG. 8 is different from FIG. 1 in that the notifying section 13 is a display provided outside the vehicle S.

For example, the information processing apparatus 30 is a computer and includes one or more physical servers or cloud servers. For example, the storage section 31 has a storage medium such as a ROM, a RAM, a HDD, or a SSD. The storage section 31 has stored therein a program for being executed by the control section 32. The storage section 31 has stored therein various types of information for detecting that loaded items U are likely to collapse and for causing the notifying section 13 to provide a notification that loaded items U are likely to collapse. For example, the control section 32 is a processor such as a CPU. By executing the program stored in the storage section 31, the control section 32 functions as the receiving section 321, the determining section 222, and the output section 223. Note that the control section 22 may include one processor or may include a plurality of processors or a combination of one or more processors and an electronic circuit.

In the warning apparatus 20, the transmitting section 231 transmits, to the information processing apparatus 30, the first acceleration and the second acceleration acquired by the acquiring section 221 via the network N. In the information processing apparatus 30, the receiving section 321 receives the first acceleration and the second acceleration from the warning apparatus 20 via the network N. Then, in the information processing apparatus 30, the output section 223 outputs warning information representing a determination result which is a result of determination by the determining section 222 as to whether or not loaded items U are likely to collapse.

### Effects of Warning Apparatus 20

As explained above, the warning apparatus 20 has: the acquiring section 221 that acquires: the first acceleration, which is the acceleration of the vehicle S detected by the first acceleration sensor 11; and the second acceleration, which is detected by the second acceleration sensor 12 and is the acceleration of the belt L that secures a loaded item U loaded in the vehicle S; and the output section 223 that outputs predetermined warning information when the difference between the first statistical value, which is a statistical value of the first acceleration, and the second statistical value, which is a statistical value of the second acceleration, is equal to or greater than the threshold.

By being configured in this manner, the warning apparatus 20 can identify that loaded items U are likely to collapse on the basis of the accelerations detected by the first acceleration sensor 11 and the second acceleration sensor 12 at a plurality of timings and cause the notifying section 13 to provide a notification. Accordingly, even when the timings at which the first acceleration sensor 11 and the second acceleration sensor 12 detect changes in the accelerations are different, the warning apparatus 20 can identify that loaded items U are likely to collapse on the basis of the accelerations detected at the plurality of timings including individual timings and cause the notifying section 13 to provide a notification. As a result, the warning apparatus 20 can enhance the accuracy of determining whether or not loaded items U are likely to collapse, and accordingly can enhance the accuracy of issuing a warning that loaded items U are likely to collapse.

Furthermore, on the basis of the second acceleration detected by the second acceleration sensor 12 attached to the belt L that secures a plurality of the loaded items U, the warning apparatus 20 can determine whether or not loaded items U are likely to collapse. Because of this, even when the number of the loaded items U loaded in the vehicle S is large, it is not necessary to provide the same number of the second acceleration sensors 12 as the number of the loaded items U, and the warning apparatus 20 can determine whether or not loaded items U are likely to collapse using a smaller number of the second acceleration sensors 12 than the number of the loaded items U.

Whereas the present invention has been explained using an embodiment thus far, the technical scope of the present invention is not limited by the scope described in the embodiment described above, but various modifications and changes are possible within the scope of a gist of the present invention. For example, all or some of apparatuses can be configured in a functionally or physically distributed or integrated manner in any units. In addition, new embodiments that are generated by any combination of a plurality of embodiments are also included in embodiments of the present invention. Effects of the new embodiments generated by the combination combine effects of the original embodiments.

1. A warning apparatus comprising:
an acquiring section that acquires: a first acceleration which is an acceleration of a vehicle detected by a first acceleration sensor; and a second acceleration which is detected by a second acceleration sensor and is an acceleration of a securing member that secures a loaded item loaded in the vehicle; and
an output section that outputs predetermined warning information when a difference between a first statistical value which is a statistical value of the first acceleration and a second statistical value which is a statistical value of the second acceleration is equal to or greater than a threshold.

2. The warning apparatus according to claim 1, wherein
the securing member is a belt whose both ends are supported within a cargo compartment of the vehicle, and
the acquiring section acquires the second acceleration detected by the second acceleration sensor attached to the belt.

3. The warning apparatus according to claim 1, wherein
the second acceleration sensor is a sensor that detects an acceleration in each of axial directions of three mutually orthogonal axes and is attached to the securing member securing the loaded item such that an axial direction of one axis among the axial directions of the three axes coincides with a vertical direction of the vehicle.

4. The warning apparatus according to claim 1, wherein
the acquiring section acquires the first acceleration and the second acceleration in each of an advancing direction, a vehicle-width direction, and a vertical direction of the vehicle, and
the output section (223) outputs the predetermined warning information when the difference between the first statistical value and the second statistical value in at least one direction among the advancing direction, the vehicle-width direction, and the vertical direction of the vehicle is equal to or greater than a threshold.

5. The warning apparatus according to claim 1, further comprising:
a determining section that notifies the output section of a determination result which is a result of determination as to whether or not a difference between a first cumulative value which is a cumulative value of the first acceleration calculated as the first statistical value and a second cumulative value which is a cumulative value of the second acceleration calculated as the second statistical value is equal to or greater than the threshold.

6. The warning apparatus according to claim 5, wherein
the determining section initializes the first cumulative value and the second cumulative value when a predetermined length of time has elapsed or the vehicle has traveled a predetermined distance from a time point at which calculation of the first cumulative value and the second cumulative value has been started.

7. The warning apparatus according to of claim 1, further comprising:
a determining section that notifies the output section of a determination result which is a result of determination as to whether or not a difference between a first average value which is an average value of the first acceleration calculated as the first statistical value and a second average value which is an average value of the second acceleration calculated as the second statistical value is equal to or greater than the threshold.

8. The warning apparatus according to claim 5, wherein
the acquiring section acquires the second acceleration from a plurality of the second acceleration sensors attached to a plurality of the securing members in a cargo compartment of the vehicle,
the determining section determines, for each of the second acceleration sensors, whether or not the difference between the first statistical value and the second statistical value is equal to or greater than the threshold, and
the output section outputs the warning information representing one or more second acceleration sensors whose difference between the first statistical value and the second statistical value is equal to or greater than the threshold from among a plurality of the second acceleration sensors.

9. The warning apparatus according to claim 1, further comprising:
an accepting section that accepts an operation for indicating that the loaded item is not loaded in a cargo compartment of the vehicle, wherein
the output section
outputs instruction information for prompting a driver of the vehicle to activate the second acceleration sensor in response to the acquiring section not being able to acquire the second acceleration after a driving source of the vehicle has started driving, and
stops output of the instruction information in response to the accepting section accepting the operation.

10. The warning apparatus according to claim 1, wherein
by outputting the warning information, the output section causes a display included in an instrument panel of the vehicle to display a warning image representing that the loaded item is likely to collapse.

11. The warning apparatus according to claim 1, wherein
by outputting the warning information, the output section causes a speaker provided around an instrument panel of the vehicle to output a sound corresponding to a message that the loaded item is likely to collapse or a warning sound.

12. The warning apparatus according to claim 8, wherein
by outputting the warning information representing the one or more second acceleration sensors, the output section causes a display included in an instrument panel of the vehicle to display an image representing sensor identification information about the one or more second acceleration sensors attached to the belts securing the loaded items that are likely to collapse.

13. The warning apparatus according to claim 1, further comprising:
a notifying section that includes a display included in an instrument panel of the vehicle and a speaker provided around the instrument panel, the notifying section causing the display to display a warning image and causing the speaker to output a warning sound in response to acceptance of the warning information output by the output section.

14. A warning method executed by a computer, the warning method comprising:
an acquisition step of acquiring: a first acceleration which is an acceleration of a vehicle detected by a first acceleration sensor; and a second acceleration which is detected by a second acceleration sensor and is an acceleration of a securing member that secures a loaded item loaded in the vehicle; and
an output step of outputting predetermined warning information in response to a difference between a first statistical value which is a statistical value of the first acceleration and a second statistical value which is a statistical value of the second acceleration being equal to or greater than a threshold.

15. A warning system comprising:
a first information processing apparatus provided to a vehicle and a second information processing apparatus provided outside the vehicle, wherein
the first information processing apparatus includes:
an acquiring section that acquires: a first acceleration which is an acceleration of the vehicle detected by a first acceleration sensor; and a second acceleration which is detected by a second acceleration sensor and is an acceleration of a securing member that secures a loaded item loaded in the vehicle; and
a transmitting section that transmits the first acceleration and the second acceleration to the second information processing apparatus, and
the second information processing apparatus includes:
a receiving section that receives the first acceleration and the second acceleration from the first information processing apparatus; and
an output section that outputs predetermined warning information when a difference between a first statistical value which is a statistical value of the first acceleration and a second statistical value which is a statistical value of the second acceleration is equal to or greater than a threshold.
